(19) United States
(12) Patent Application Publication
(10) Pub. No.: US 2002/0141788 A1
(43) Pub. Date: Oct. 3, 2002

(54) Image forming apparatus and developer supplying container detachably attachable thereto

(75) Inventors: Kenji Matsuda, Shizuoka (JP); Akiyoshi Fujita, Shizuoka (JP); Nobuharu Hoshi, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/106,316

(22) Filed: Mar. 27, 2002

(30) Foreign Application Priority Data
Mar. 30, 2001 (JP) 101515/2001

(51) Int. Cl. G03G 15/08

(52) U.S. Cl. 399/260

(57) ABSTRACT

In conventional image forming apparatus, there is a type of a printer in which a developing device and a developer supplying container are separately provided and the developer supplying container is replaced individually to supply a developer that is an expendable agent. The printer of this type has an advantage in which a component having a relatively long durable life is unnecessary to replace frequently, while the printer has a disadvantage in which leakage of the developer easily occurs when the developer supplying container is removed from the printer main body. Therefore, an image forming apparatus capable of controlling leakage of developer is provided.

### BACKGROUND OF THE INVENTION

1. Field of the Invention

The present invention relates to an image forming apparatus such as a copying machine and a printer, which uses a recording system such as an electrophotographic recording system and an electrostatic recording system, and a developer supplying container detachably attachable to this apparatus.

2. Related Background Art

Many copying machines and printers employed in these days are those of a cartridge type that can be easily maintained.

For example, in a printer using the electrophotographic recording technology, a photosensitive body and a developing device are incorporated into one cartridge that is detachably attachable to a printer main body. Alternatively, a photosensitive body and a cleaning device are incorporated into one cartridge and a developing device is attached to and detached from a printer main body as a separate cartridge. Thus, there are a variety of forms of a cartridge.

Among them, there is also a form of a printer in which a developing device and a developer supplying container are separately provided and the developer supplying container is replaced individually to supply a developer that is an expendable agent. The printer of this type is economical because it is unnecessary to replace components in the developing device, for example, a component with a relatively long durable life such as a developing roller, every time the developer is supplied. In addition, a cartridge can be easily replaced because it is made compact However, it is necessary to cope with leakage of the developer when the developer supplying container is removed from the printer main body.

### SUMMARY OF THE INVENTION

The present invention has been devised in view of the above-mentioned drawbacks, and it is an object of the present invention to provide an image forming apparatus capable of controlling leakage of developer and a unit detachably attachable to this apparatus.

Another object of the present invention is to provide an image forming apparatus, comprising: a unit detachably attachable to a main assembly of the image forming apparatus, the unit having a discharge opening for discharging a developer and a shutter for opening and closing the discharge opening; and developing means for developing a latent image formed on an image bearing member by the developer, the developing means having a supply opening connected to the discharge opening, in which the unit has a groove through which a moving body for moving the shutter passes and a brush member is attached to the groove.

Still another object of the present invention is to provide an image forming apparatus, comprising: developing means for developing a latent image formed on an image bearing member by a developer, the developing means being detachably attachable to a main assembly of the image forming apparatus; and a supplying container for containing the developer to be supplied to the developing means, the supplying container having a discharge opening for discharging the developer and a shutter for opening and closing the discharge opening, in which the supplying container has a groove through which a moving body for moving the shutter passes and a brush member is attached to the groove.

Still another object of the present invention is to provide a unit detachably attachable to an image forming apparatus, comprising: a groove through which a part of a moving body that is movable relative to the unit passed; and a brush member attached to the groove, in which, when the moving body passes through the groove, the moving body contacts the brush member.

These and other objects and advantages of the invention may be readily ascertained by referring to the following description and accompanying drawings.

### BRIEF DESCRIPTION OF THE DRAWINGS

FIG. 1 shows a longitudinal section of an image forming apparatus (color laser beam printer) in accordance with the present invention;

FIG. 2 shows a longitudinal section of a process cartridge and a toner supplying container in accordance with the present invention;

FIG. 3 is a perspective view showing a state in which a front door of the image forming apparatus (color laser beam printer) in accordance with the present invention is open;

FIG. 4 shows a cross section in the longitudinal direction of the process cartridge;

FIG. 5 shows a longitudinal section in the longitudinal direction of the toner supplying container and the process cartridge in accordance with the present invention;

FIG. 6 is a perspective view showing a state in which a discharge opening cover of the toner supplying container in accordance with the present invention is closed;

FIG. 7 is a perspective view showing a discharge opening portion of the toner supplying container in accordance with the present invention;

FIG. 8 is a perspective view of a process cartridge;

FIG. 9A is a schematic view showing an operation of a discharge opening shutter of the toner supplying container at the time when the process cartridge is being mounted, and

FIG. 9B is a schematic view showing an operation of the discharge opening shutter of the toner supplying container at the time when the toner supplying container is being mounted;

FIG. 10 is a perspective view showing a state in which the discharge opening cover of the toner supplying container in accordance with the present invention is open;

FIG. 11A is a schematic view showing a pressing member, the discharge opening shutter, a brush curtain and a guide pin of the toner supplying container in accordance with the present invention, and

FIG. 11B is a sectional view thereof in an illustrated position of FIG. 11A;

FIG. 12 shows a longitudinal section of the discharge opening portion of the toner supplying container in accordance with the present invention;

FIG. 13 is a schematic view showing a relationship between a slit opened in the pressing member and a moving locus of a second opening opened in the discharge opening shutter of the toner supplying container in accordance with the present invention;

FIG. 14 is a perspective view showing the discharge opening portion of the toner supplying container in accordance with the present invention; and

FIG. 15A is a schematic view showing the pressing member, the discharge opening shutter, the brush curtain and the guide pin of the toner supplying container in accordance with the present invention, and

FIG. 15B is a sectional view, thereof in an illustrated position of FIG. 15A.

### DETAILED DESCRIPTION OF THE PREFERRED EMBODIMENTS

Embodiments of the present invention will be hereinafter described in detail with reference to the accompanying drawings.

Note that, in the following description, a longitudinal direction means a direction identical with an axial direction of an electrophotographic photosensitive drum (hereinafter referred to as a photosensitive drum). In addition, on the basis of a direction of inserting a cartridge in an electrophotographic image forming apparatus, an inserting direction is referred to as an inner side and a pulling-out direction is referred to as a front side. Moreover, the term “up and down” means up and down in a mounted state of the cartridge.

(Description of an Entire Image Forming Apparatus)

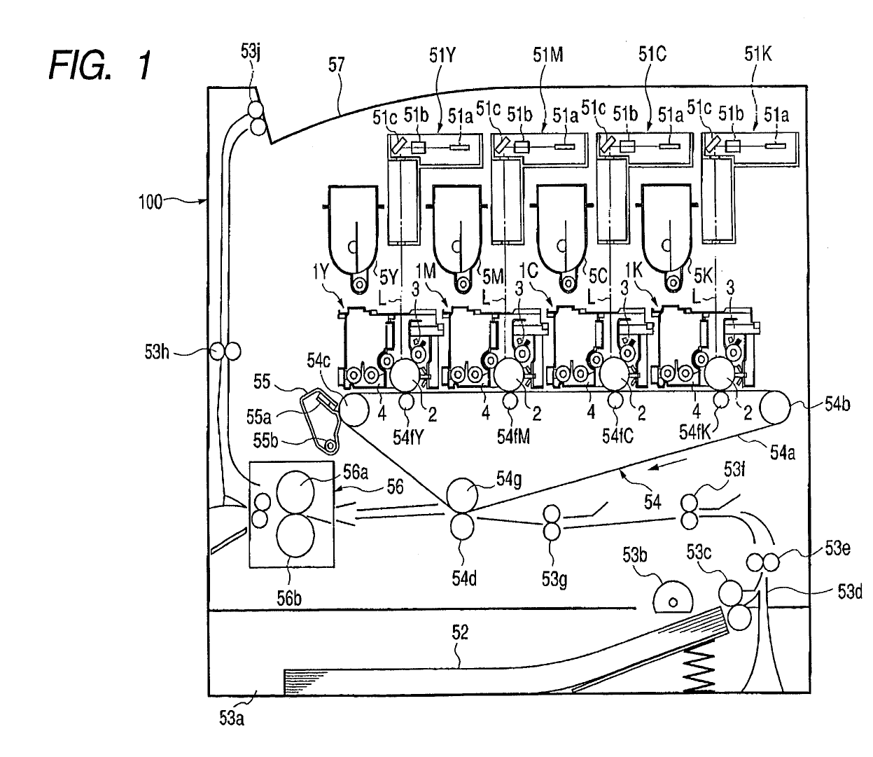

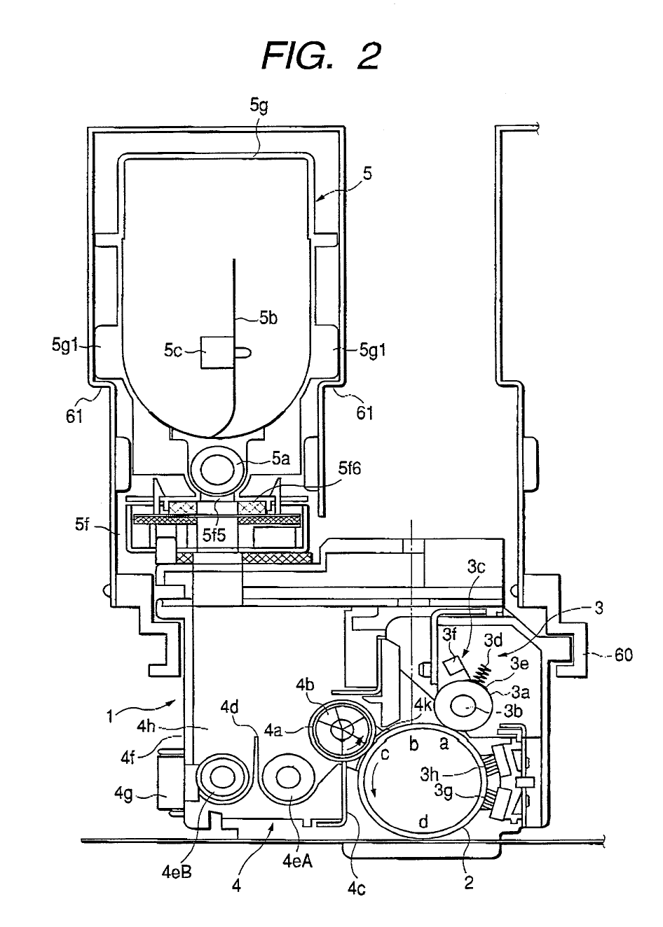

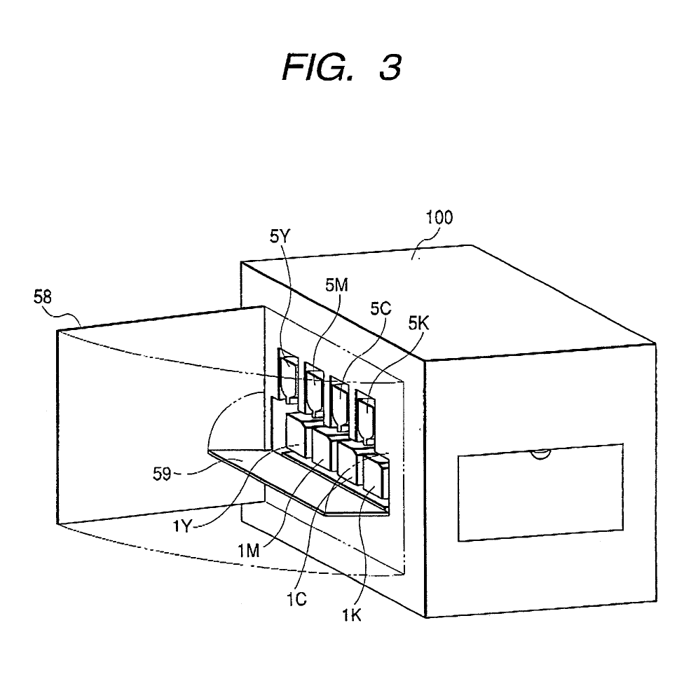

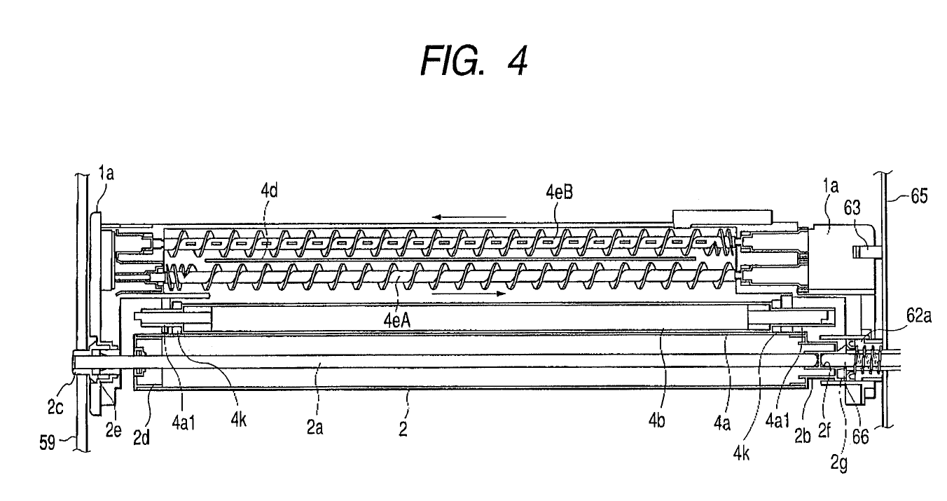

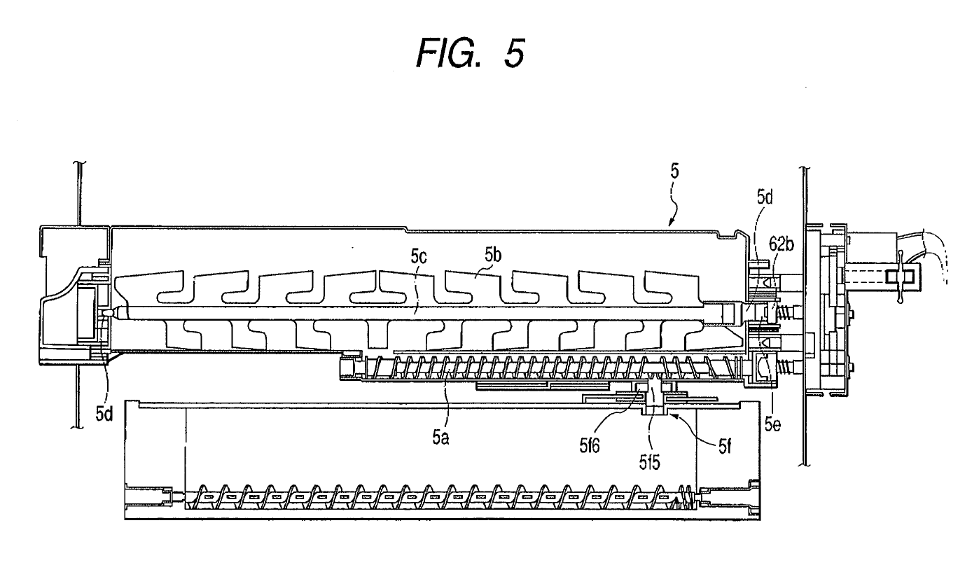

FIG. 1 is a sectional view showing an entire configuration of a color laser beam printer as one form of a color image forming apparatus FIG. 2 is a sectional view of a process cartridge and a toner supplying container in accordance with the present invention. FIG. 3 is a perspective view of the image forming apparatus. FIG. 4 is a planar sectional view in the longitudinal direction of the process cartridge. FIG. 5 is a sectional view of the toner supplying container.

First, the entire configuration of the color laser beam printer will be described with reference to FIG. 1.

An image forming unit of the color laser beam printer shown in FIG. 1 is provided with four process cartridges 1Y (yellow), 1M (magenta), 1C (cyan) and 1K (black) including photosensitive drums 2 functioning as image bearing members and exposing means (laser beam optical scanning systems) 51Y, 51M, 51C and 51K arranged in parallel with each other corresponding to each color above the process cartridges 1 (1Y, 1M, 1C and 1K).

In addition, below the image forming unit, there are disposed feeding means for feeding recording media 52, an intermediate transferring belt 54a for transferring a toner image formed on the photosensitive drum 2, a secondary transfer roller 54d for transferring the toner image on the intermediate transferring belt 54a to the recording media 52, a fixing device 56 for fixing the toner image transferred to the recording media 52 and discharge rollers 53h and 53j for discharging the recording media 52 to the outside and stacking them.

Here, as the recording medium 52, for example, a sheet, an OHP sheet and a cloth are used. Note that, the color laser beam printer in accordance with this embodiment is an apparatus employing a cleaner-less system, in which transfer residual toner remaining on the photosensitive drums 2 is collected in developing apparatuses and dedicated cleaners for collecting and storing the transfer residual toner are not disposed in the process cartridges 1 (1Y, 1M, 1C and 1K).

Next, a structure of the above-mentioned each unit will be described in detail one by one.

(Feeding Means)

The feeding means is for feeding the recording media 52 to the image forming unit and is mainly constituted by a feeding cassette 53a in which a plurality of recording media 52 are stacked and contained, a feeding roller 53b, a retard roller pair 53c for preventing double feed, a feeding guide 53d and a registration roller pair 53g.

The feeding roller 53b is rotated according to an image forming operation and separates to feed the recording media 52 in the feeding cassette 53a one by one. The recording media 52 are prevented from being fed doubly by the retard roller pair 53c and are guided by the feeding guide 53d to be conveyed to the registration roller pair 53g via conveying roller pairs 53e and 53f.

The registration roller pair 53g performs a non-rotating operation for causing the recording medium 52 to be stationary in a standby state during an image forming operation and a rotating operation for conveying the recording medium 52 toward the intermediate transferring belt 54a in a predetermined sequence. In this way, the registration roller pair 53g performs positioning of a toner image and the recording medium 52 at the time of a transfer step that is the next step.

Immediately after the recording medium 52 is conveyed, the registration roller pair 53a stops rotation and the recording medium 52 abuts a nip portion of the registration roller pair 53g, whereby skew feeding is corrected.

(Process Cartridge)

The process cartridges 1 (1Y, 1M, 1C and 1K) are integrally constituted with charging devices 3 and developing apparatuses 4 disposed around the photosensitive drums 2 functioning as image bearing members. These process cartridges 1 (1Y, 1M, 1C and 1K) can be easily removed from an apparatus main body 100 by users and are replaced with new ones when the photosensitive drums 2 have exhausted their lives.

In this embodiment, for example, the number of rotations of the photosensitive drums 2 is counted. If the number of rotations exceeds a predetermined count number, it is informed that the process cartridges 1 (1Y, 1M, 1C and 1K) have reached their lives.

The photosensitive drum 2 in accordance with this embodiment is a negatively charged organic photosensitive body This is constituted by forming a photosensitive layer usually used on a hollow cylindrical drum base body of aluminum with a diameter of approximately 30 mm. A charge injecting layer is provided in an uppermost surface layer. In addition, this photosensitive drum 2 is rotated at a predetermined process speed (in this embodiment, approximately 117 mm/sec). Further, as the charge injecting layer, a coated layer of a material made of binder of insulating resin scattered with, for example, SnO₂ ultra-fine particles as conductive fine particles is used.

As shown in FIG. 4, a drum flange 2b is fixed into an inner side end portion in a longitudinal direction of a drum base body 2h of the photosensitive drum 2 (right end portion in FIG. 4) and a driven flange 2d is fixed into the front end portion (left end portion in FIG. 4). A drum shaft 2a pierces the centers of the drum flange 2b and the driven flange 2d. The drum shaft 2a and the driven flange 2d engage with each other to integrally rotate. Then, the drum base body 2h, the drum shaft 2a, the drum flange 2b and the driven flange 2d are rotated integrally. That is, the photosensitive drum 2 is rotated around the axis of the drum shaft 2a.

In addition, the front side end portion of the drum shaft 2a is rotatably supported by a bearing 2, which is fixed to a bearing case 2c. Further, the bearing case 2c is fixed to a frame 1a of the process cartridge 1 (1Y, 1M, 1C or 1K).

(Charging Means)

The charging device 3 as charging means uses a contact charging system. As shown in FIG. 2, a charging roller 3a is used as charging member in this embodiment. This charging roller 3a is rotatably held by bearing members (not shown) at both ends of a core metal 3b and, at the same time, biased in the direction of the photosensitive drum 2 by a compressing coil spring 3d. Thus, it is in press contact with the surface of the photosensitive drum 2 with a predetermined pressing force, thereby rotating in accordance with the rotation of the photosensitive drum 2.

Reference symbol 3c denotes a charging roller cleaning member, which is constituted by attaching a flexible cleaning film 3e to a supporting member 3f in this embodiment Here, the cleaning film 3e is disposed in parallel with the charging roller 3a in its longitudinal direction. One end of the cleaning film 3e is fixed to the supporting member 3f that performs reciprocation of a fixed amount with respect to the longitudinal direction. The surface of the cleaning film 3e in the vicinity of its free end side forms a contact nip with the charging roller 3a. In addition, the supporting member 3f is reciprocatively driven in a fixed amount in the longitudinal direction by driving means (not shown) and the surface of the charging roller 3a is rubbed by the cleaning film 3e. Consequently, deposits such as fine powder toner and externally added agent on the surface of the charging roller 3a are removed.

Note that, the color laser beam printer in accordance with this embodiment employs a cleaner-less system described below.

(Cleaner-Less System)

A cleaner-less system employed in this embodiment is for carrying transfer residual toner on the photosensitive drum 2 after transfer to a developing portion c through a charging portion a and an exposing portion b following the subsequent rotation of the photosensitive drum 2, thereby carrying out cleaning simultaneous with development of the transfer residual toner (collecting the transfer residual toner) by a developing apparatus 4.

Since the transfer residual toner on the surface of the photosensitive drum 2 is carried through the exposing portion b, an exposing process is performed onto the transfer residual toner. However, since the amount of the transfer residual toner is small, the exposing process is not significantly affected. Nevertheless, it is likely that toner of a normal polarity, toner of a reverse polarity (reversed toner) and toner with a little charge amount are mixed in the transfer residual toner and the reversed toner or the toner with a little charge amount deposits on the charging roller 3a when it passes through the charging portion a, whereby the charging roller 3a is contaminated by the toner in excess of allowable or higher level and charging defect is caused.

In addition, in order to effectively carrying out the cleaning simultaneous with development of the transfer residual toner on the surface of the photosensitive drum 2 by the developing apparatus 4, it is required that the charging polarity of the transfer residual toner on the photosensitive drum 2 to be carried to the developing portion c is normal. and a charge amount of the transfer residual toner is in a level for allowing the developing apparatus 4 to develop an electrostatic latent image of the photosensitive drum 2. The reversed toner or toner with an inappropriate charge amount cannot be removed and collected in the developing apparatus 4 from the surface of the photosensitive drum 2 and becomes a cause of a defective image.

In addition, with diversification of users' demand in recent years, a large amount of transfer residual toner is generated by continuous print operations and the like of images of a high printing ratio such as a photograph image, which worsens the above-mentioned problem.

Thus, in this embodiment, transfer residual toner (residual developer image) equalizing means 3g for equalizing transfer residual toner on the photosensitive drum 2 is provided in a position on the more downstream side in the rotating direction of the photosensitive drum 2 than a transfer portion d. In addition, toner (developer) charging controlling means 3h for making a charging polarity of the transfer residual toner to be uniformly negative, that is a normal polarity, is provided in a position on the more downstream side in the rotating direction of the photosensitive drum 2 than the transfer residual toner equalizing means 3g and on the more upstream side in the rotating direction of the photosensitive drum 2 than the charging portion a.

Since the transfer residual toner equalizing means 3g is provided, even if there is a large amount of pattern-like transfer residual toner on the photosensitive drum 2 carried from the transfer portion d to the toner charging controlling means 3h, the transfer residual toner is scattered and distributed on the surface of the photosensitive drum 2 to be made non-patterned. Thus, toner does not concentrate on a part of the toner charging controlling means 3h and overall normal polarity charging processing of the transfer residual toner by the toner charging controlling means 3h is always performed sufficiently, whereby deposition of the transfer residual toner on the charging roller 3a is effectively prevented and occurrence of a ghost image of a transfer residual toner image pattern is also prevented.

In this embodiment, the transfer residual toner equalizing means 3g and the toner charging controlling means 3h are formed of a brush-like member having an appropriate conductivity and are disposed with the brush part being contacted the surface of the photosensitive drum 2.

In addition, the transfer residual toner equalizing means 3g and the toner charging controlling means 3h are configured to move (reciprocate) along the longitudinal direction of the photosensitive drum 2 by a driving source (not shown). In this way, the transfer residual toner equalizing means 3g and the toner charging controlling means 3h do not stay at the same position on the photosensitive drum 2. For example, even if there is an excessively charged part or an insufficiently charged part due to resistance unevenness of the toner charging controlling means 3h, since these do not always occur in the same part of the surface of the photosensitive drum 2, occurrence of fusing on the photosensitive drum 2 by locally excessive charging of the transfer residual toner or deposition of the transfer residual toner on the charging roller 3a due to insufficient charging is prevented or eased.

(Exposing Means)

In this embodiment, exposure of the photosensitive drum 2 is performed using laser exposing means 51Y, 51M, 51C and 51K. That is, when an image signal is sent from the apparatus main body 100, a uniformly charged surface of the photosensitive drum 2 is scanned and exposed by a laser beam L that is modulated in response to this signal. Then, an electrostatic latent image corresponding to image information is selectively formed on the surface of the photosensitive drum 2.

As shown in FIG. 1, the laser exposing means 51Y, 51M, 51C and 51K are constituted by solid laser elements (not shown), polygon mirrors 51a, focusing lenses 51b, reflective mirrors 51c and the like. The solid laser elements are turned on/off to be controlled to emit light at predetermined timing by a light emission signal generator (not shown) based on an inputted image signal Laser beams L emitted from the solid laser elements are converted into substantially parallel luminous fluxes by a collimator lens system (not shown). The luminous fluxes are scanned by the polygon mirror 51a rotating at a high speed and are focused on the photosensitive drum 2 in spots via the focusing lens 51b and the reflective mirror 51c.

In this way, exposure in a main scanning direction by the laser beam scanning and exposure in a sub-scanning direction by the rotation of the photosensitive drum 2 are applied to the surface of the photosensitive drum 2, whereby an exposure distribution according to an image signal is obtained. That is, a light portion potential part in which a surface potential is reduced and a dark position potential part in which surface potential is not reduced are formed on each photosensitive drum 2. according to irradiation and non-irradiation of the laser beam L. An electrostatic latent image corresponding to image information is formed on each photosensitive drum 2 according to a contrast between the light portion potential part and the dark portion potential part.

(Developing Means)

The developing apparatus 4 functioning as developing means is a two-component contact developing apparatus (two-component magnetic brush developing device). As shown in FIG. 2, the developing apparatus 4 holds a developer consisting of carrier and toner on a developing sleeve 4a functioning as a developer bearing member containing a magnet roller 4b. The developing sleeve 4a is provided with a regulating blade 4c at a predetermined interval. A thin layer of the developer is formed on the developing sleeve 4a following the rotation of the developing sleeve 4a in an arrow direction. Further, although the two-component. magnetic brush developing apparatus is used as the developing apparatus 4 in this embodiment, the developing apparatus is not limited to this.

As shown in FIG. 4, the developing sleeve 4a is disposed such that by rotatably fitting a roller-like spacer 4k into contracted-diameter journal portions 4a1 on its both sides, a predetermined gap is formed between the photosensitive drum 2 and the developing sleeve 4a. The developing sleeve 4a is set such that, in development, a development ca n be performed with the developer formed thereon contacting the photosensitive drum 2. In addition, as shown in FIG. 2, the developing sleeve 4a is rotated in an illustrated arrow direction (counterclockwise direction) at a predetermined peripheral speed such that its circumferential surface moves in a counter direction with respect to a moving direction of the circumferential surface of the photosensitive drum 2 at a developing portion.

In this embodiment, negatively charged toner with an average particle diameter of 6 μm is used as the toner and magnetic carrier with an average particle diameter of 35 μm and saturation magnetization of 205 emu/cm³ is used as the magnetic carrier. In addition, a mixture of toner and carrier at a weight ratio of 6:94 is used as the developer. Further, the developer is not limited to the mixture of toner and magnetic carrier and magnetic toner can be used as the developer.

As shown in FIG. 2, a developer containing portion 4h in which the developer is circulating is partitioned into two parts by a partition wall 4d provided over its longitudinal direction excluding its both end parts. Agitating screws 4eA and 4eB are disposed on its both sides across the partition wall 4d.

As shown in FIG. 4, toner supplied from toner supplying containers 5 (5Y, 5M, 5C and 5K) falls into the inner side of the agitating screw 4eB (the right side in FIG. 4) and is agitated while being fed to the front side in the longitudinal direction (the left side in FIG. 4) to pass a part at the end on the front side where the partition wall 4d does not exist. Then, the toner is fed to the much inner side in the longitudinal direction (the right side in FIG. 4) by the agitating screw 4eA to pass through a part on the inner side where the partition wall 4d does not exist and is agitated again by the agitating screw 4eB while being fed by it to repeat circulation.

Here, a developing process for visualizing an electrostatic latent image formed on the photosensitive drum 2 by a two-component magnetic brush method using the developing apparatus 4 and a circulation system of a developer will be described with reference to FIG. 2.

According to a rotation of the developing sleeve 4a, the developer in the developer containing portion 4h is drawn up to the surface of the developing sleeve 4a at a draw-up pole of the magnetic roller 4b and conveyed. In the course of the developer being conveyed, a layer thickness of the developer is regulated by the regulating blade 4c that is disposed vertically with respect to the developing sleeve 4a and a thin layered developer is formed on the developing sleeve 4a. Then, when the thin layered developer is conveyed to a developing pole corresponding to the developing portion c, a magnetic brush of the developer is formed by a magnetic force. The electrostatic latent image on the surface of the photosensitive drum 2 is developed as a toner image by toner in the developer standing like the ears of rice. Further, the electrostatic latent image is subjected to reversal development in this embodiment.

The thin-layered developer on the developing sleeve 4a, which has passed through the developing portion, subsequently enters the developer containing portion 4h following the rotation of the developing sleeve 4a and removes from the developing sleeve 4a by a repulsive magnetic field of the conveying pole to be returned to the developer containing portion 4h.

A direct current (DC) voltage and an alternating current (AC) voltage are applied to the developing sleeve 4a from power sources (not shown). In this embodiment, a direct current voltage of −500 V and an alternating current voltage with a peak-to-peak voltage of 1500 V at a frequency of 2000 Hz are applied to the developing sleeve 4a, whereby only an exposed portion of the photosensitive drum 2 is selectively developed.

In general, in the two-component development method, when an alternating current voltage is applied, a developing efficiency is increased to make an image high in grade. However, on the other hand, a deficiency occurs in that a fogged image tends to be generated. Thus, usually, a fogged image is prevented by providing a potential difference between a direct current voltage applied to the developing sleeve 4a and a surface potential of the photosensitive drum 2. More specifically, a bias voltage of a potential difference between a potential of an exposed portion and a potential of an unexposed portion of the photosensitive drum 2 is applied.

Therefore, when the toner is consumed by development, a toner density in the developer decreases. In this embodiment, a sensor 4g (see FIG. 2) for sensing a toner density is disposed in a position close to the external circumferential surface of the agitating screw 4eB as shown in FIG. 2. When the sensor 4g senses that the toner density in the developer has decreased to be lower than a predetermined density level, an instruction to supply toner in the developer containing portion 4h of the developing apparatus 4 is outputted from each of the toner supplying containers 5 (5Y, 5M, 5C and 5K). The toner density of the developer is always maintained at a predetermined level by this toner supply operation.

(Toner Supplying Container)

The toner supplying containers (units) 5 (5Y, 5M, 5C and 5K) are disposed in parallel with each other above the process cartridges 1 (1Y, 1M, 1C and 1K), respectively, and are mounted in the apparatus main body 100 from its front.

As shown in FIG. 2. in each of the toner supplying containers 5 (5Y, 5M, 5C and 5K), toner or a mixture of toner and magnetic carrier is contained inside a frame body 5g functioning as a toner containing portion (developer containing portion), an agitating plate 5b fixed to an agitating shaft 5c and a screw 5a are disposed and a discharge opening portion 5f for discharging toner is formed on the bottom surface of the container. As shown in FIG. 5, the screw 5a and the agitating shaft 5c are rotatably supported by bearings 5d at their both ends and a driving coupling (concave) 5e is disposed in the endmost part on the inner side (the right side in FIG. 5). This driving coupling (concave) 5e receives transmission of a driving force from a driving coupling (convex). 62b of the apparatus main body 100 and is rotated.

An external portion of the screw 5a is formed in a spiral rib shape and a twisting direction of the spiral is reversed around the discharge opening portion 5f. Then, the screw 5a is rotated in a predetermined rotating direction by the rotation of the driving coupling (convex) 62b, whereby the toner is conveyed to the discharge opening portion 5f. The toner is caused to free-fall by the discharge opening portion 5f to be supplied to each of the process cartridges 1 (1Y, 1M, 1C and 1K).

A tip portion in the rotational radial direction of the agitating plate 5b is inclined and, when it rubs the wall surface of each of the toner supplying containers 5 (5Y, 5M, 5C and 5K), the tip end portion of the agitating plate 5b is abutted with a certain angle. More specifically, the tip side of the agitating plate 5b is twisted to be in a spiral state. As the tip side of the agitating plate 5b is twisted and inclined in this way, a conveying force in the axial direction is generated to feed the toner in the longitudinal direction.

Further, the toner supplying containers 5 (5Y, 5M, 5C and 5K) in accordance with this embodiment are not limited to be used in the two-component development method and can supply toner in a process cartridge or a development cartridge using a one-component development method. In addition, powder to be contained in the toner supplying containers 5 (5Y, 5M, 5C and 5K) is not limited to toner and may be a developer that is a mixture of toner and magnetic carrier.

(Transferring Means)

An intermediate transferring unit 54 functioning as transferring means shown in FIG. 1 is for secondarily transferring a plurality of toner images onto a recording medium 54, which are primarily transferred from the photosensitive drums 2 and superposed one after another, collectively.

As shown in FIG. 1, the intermediate transferring unit 54 is provided with the intermediate transferring belt 54a running in an illustrated arrow direction. The intermediate transferring belt 54a runs in the illustrated arrow direction (clockwise direction) at a peripheral speed which is substantially the same as an external peripheral speed of the photosensitive drums 2. The intermediate transferring belt 54a is an endless belt with a circumferential length of approximately 940 mm and is laid over three rollers, namely, the driving roller 54b, a secondary transfer opposing roller 54g and a driven roller 54c.

In addition, transfer charging rollers 54fY, 54fM, 54fC and 54fK are rotatable disposed in positions opposing the photosensitive drums 2, respectively, inside the intermediate transferring belt 54a and are pressured in the direction to the centers of the photosensitive drums 2.

The transfer charging rollers 54fY, 54fM, 54fC and 54fK are supplied with power from a high voltage power source (not shown) and perform charging of a polarity opposite that of the toner from the back side of the intermediate transferring belt 54a, thereby primarily transferring toner images on the photosensitive drums 2 to the upper surface of the intermediate transferring belt 54a one after another.

In a secondary transfer portion, the secondary transfer roller 54d as a transferring member is in press contact with the intermediate transferring belt 54a in a position opposing the secondary transfer opposing roller 54g. The secondary transfer roller 54d is swingable in the vertical direction of FIG. 1 and rotates Then, the secondary transfer roller 54d is away from the intermediate transferring belt 54a such that it does not harm an image on the intermediate transferring belt 54a until images are sequentially superposed and transferred onto the intermediate transferring belt 54a and a multi-color image is completed.

Here, the intermediate transferring belt 54a and the secondary transfer roller 54d are driven, respectively. When the recording medium 52 rushes in the secondary transfer portion, a predetermined bias is applied to the secondary transfer roller 54 and a toner image on the intermediate transferring belt 54a is secondarily transferred to the recording medium 52. At this point, the recording medium 52 nipped between the intermediate transferring belt 54a and the secondary transfer roller 54d is subjected to a transfer process and, at the same time, conveyed in the left direction in FIG. 1 at a predetermined speed to the fixing device 56 for fixing processing that is the next process.

A cleaning unit 55 capable of contacting and separating with respect to the surface of the intermediate transferring belt 54a is provided in a predetermined position of the intermediate transferring belt 54a that is the most downstream side in the transfer process. Transfer residual toner remaining after the secondary transfer is removed by the cleaning unit 55.

As shown in FIG. 1, a cleaning blade 55a for removing transfer residual toner is disposed in the cleaning unit 55. The cleaning unit 55 is swingably attached at its rotational center (not shown) and the cleaning blade 55a is in press contact with the intermediate transferring belt 54a in a direction of biting into it. The transfer residual toner collected in the cleaning unit 55 is conveyed to a waste toner tank (not shown) by a feeding screw 55b and stored therein.

Here, a belt made of polyimide resin can be used as the intermediate transferring belt 54a. A material for the intermediate transferring belt 54a is not limited to polyimide resin, and plastic such as polycarbonate resin, polyethylene terephthalate resin, polyvinylidene fluoride resin, polyethylene naphthalate resin, polyether etherketone resin, polyether sulfone resin and polyurethane resin, fluoride-based or silicon-based rubber and the like can be used preferably.

(Fixing Unit)

As described above, the toner image formed on the photosensitive drum 2 by the developing apparatus 4 is transferred onto the recording medium 52 via the intermediate transferring belt 54a. Then, the fixing device 56 fixes the toner image transferred to the recording medium 52 thereon using heat.

As shown in FIG. 1, the fixing device 56 is provided with a fixing roller 56a for applying heat to the recording medium 52 and a pressure roller 56b for bringing the recording medium 52 to be in press contact with the fixing roller 56a. The fixing rollers 56a and the pressure roller 56b are constituted by hollow rollers, in which heaters (not shown) are provided, respectively. In addition, the fixing roller 56a and the pressure roller 56b are rotated, thereby conveying the recording medium 52 simultaneously.

That is, the recording medium 52 holding the toner image is conveyed by the fixing roller 56a and the pressure roller 56b and applied with heat and pressure, thereby fixing the toner image thereonto. Then, the recording medium 52 after fixing of the toner image is discharged by the discharge rollers 53h and 53j and stacked in a tray 57 on the apparatus main body 100.

(Mounting of a Process Cartridge and a Toner Supplying Container)

Next, procedures for mounting the process cartridges 1 (1Y, 1M, 1C and 1K) and the toner supplying containers 5 (5Y, 5M, 5C and 5K) in the apparatus main body 100 will be described with reference to FIGS. 2 and 5.

FIG. 3 is a perspective view schematically showing the appearance of the apparatus main body 100. As shown in the figure, a front door 58 capable of opening and closing is disposed in the front surface of the apparatus main body 100. When the front door 58 is pulled to the front side, openings in which the process cartridges 1Y, 1M, 1C and 1K and the toner supplying containers 5Y, 5M, 5C and 5K are inserted are exposed.

A rotatably supported centering plate 59 is disposed in the openings in which the process cartridges 1Y, 1M, 1C and 1K are inserted. The process cartridges 1Y, 1M, 1C and 1K are inserted and pulled out after the centering plate 59 is opened. As shown in FIG. 2, a guide rail 60 for guiding mounting of the process cartridges 1Y, 1M, 1C and 1K and a guide rail 61 for guiding mounting of the toner supplying container 5Y, 5M, 5C and 5K are provided in the apparatus main body 100.

A direction of mounting the process cartridges 1Y, 1M, 1C and 1K and the toner supplying containers 5Y, 5M, 5C and 5K is parallel with the axial direction of the photosensitive drum 2. The guide rails 60 and 61 are also disposed in the same direction. The process cartridges 1Y, 1M, 1C and 1K and the toner supplying containers 5Y, 5M, 5C and 5K are slid to be inserted from the front side to the inner side in the apparatus main body 100 along the guide rails 60 and 61.

When the process cartridges 1Y, 1M, 1C and 1K are inserted to the innermost part, a centering shaft 66 of the apparatus main body 100 is inserted in a central hole 2f of the drum flange 2b as shown in FIG. 4 and a rotational central position on the inner side of the photosensitive drum 2 is defined with respect to the apparatus main body 100. In addition; simultaneously with this, a drive transmitting portion 2g formed in the drum flange 2b and a driving coupling (concave) 62a of the apparatus main body 100 are coupled and the photosensitive drum 2 is allowed to be rotated. Further, the drive transmitting portion 2g used in this embodiment is formed in a twisted triangular prism shape. As a driving force from the apparatus main body 100 is applied to it, the driving force is transmitted to the photosensitive drum 2 and a force pulling the photosensitive drum 2 to the inner side is generated.

In addition, as shown in FIG. 4, a support pin 63 for positioning the process cartridge 1Y, 1M, 1C or 1K is disposed on a rear side plate 65. As the support pin 63 is inserted in the frame 1a of the process cartridge 1Y, 1M, 1C or 1K and a position of the frame 1a is fixed.

As shown in FIG. 4, the rotatable centering plate 59 is disposed on the front side of the apparatus main body 100 (the left side in FIG. 4). The bearing case 2c of the process cartridge 1Y, 1M, 1C or 1K fits in the centering plate 59, whereby the process cartridge 1Y, 1M, 1C or 1K is supported and fixed. According to a set of these inserting operations, the photosensitive drum 2 and the process cartridge 1Y, 1M, 1C or 1K are positioned with respect to the apparatus main body 100.

On the other hand, as shown in FIG. 5, when the toner supplying container 5Y, 5M, 5C or 5K is inserted to the inner most portion in the same manner as the process cartridge 1Y, 1M, 1C or 1K, it is fixed to the support pin 63 protruding from the rear side plate 65. In addition, simultaneous with this, the driving coupling (concave) 5e and the driving coupling (convex) 62b are coupled to allow the screw 5a and the agitating shaft 5c to be rotated.

In addition, in order to pull out the process cartridge 1Y, 1M, 1C or 1K or the toner supplying container 5Y, 5M, 5C or 5K from the apparatus main body 100, it is sufficient to carry out the above-mentioned procedures in the reverse order.

Further, in this embodiment, the process cartridges 1Y, 1M, 1C and 1K and the toner supplying containers 5Y, 5M, 5C and 5K can be detachably attachable to the apparatus main body 100 in random order.

That is, the toner supplying containers 5Y, 5M, 5C and 5K may be inserted in the apparatus main body 100 after the process cartridges 1Y, 1M, 1C and 1K are inserted first or the process cartridges 1Y, 1M, 1C and 1K may be inserted in the apparatus main body 100 after the toner supplying containers 5Y, 5M, 5C and 5K are inserted first.

Moreover, the toner supplying containers 5Y, 5M, 5C and 5K may be pulled out from the apparatus main body 100 after the process cartridges 1Y, 1M, 1C and 1K are pulled out first or the process cartridges 1Y, 1M, 1C and 1K may be pulled out from the apparatus main body 100 after the toner supplying containers 5Y, 5M, 5C and 5K are pulled out first.

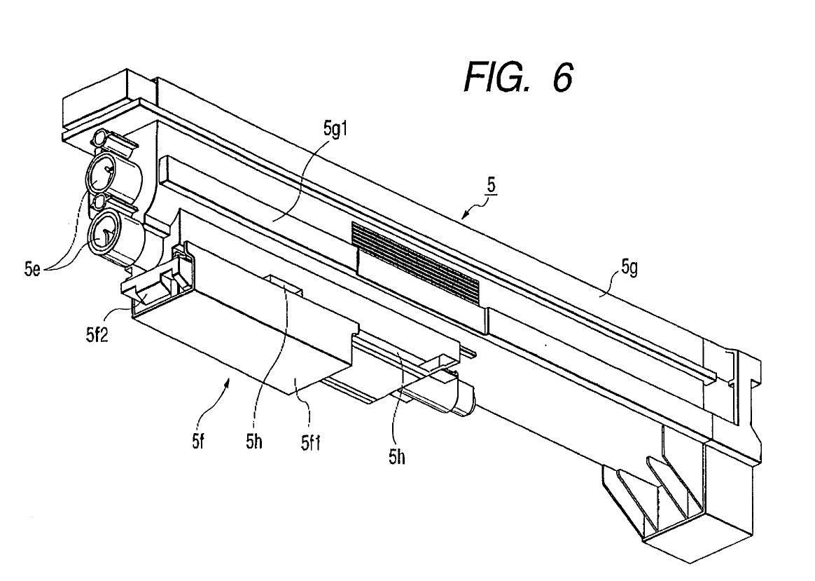

Next, the gist of the present invention will be described with reference to FIGS. 6 to 15B.

FIG. 6 is a perspective view of the toner supplying container 5 in accordance with the present invention viewed diagonally from a bottom surface side on its inner side. As shown in the figure, guide portions 5g1 (only one of them is shown in FIG. 6) to be a guide in inserting the toner supplying container 5 in the apparatus main body 100 are provided on both sides of the frame body 5g forming a toner containing portion of the toner supplying container 5. These guide portions 5g1 are provided protrudingly to the outside from both the sides of the toner supplying container 5 to form a convex shape and is provided linearly over its longitudinal direction. In addition, a lower surface of each guide portion 5g1 forms a smooth plane shape and, when the toner supplying container 5 is inserted in the apparatus main body 100, the toner supplying container 5 engages with the apparatus main body 100 and is positioned with the bottom surfaces of the guide portions 5g1 mounted on the upper surface of the guide rail 61 provided on the apparatus main body 100 (see FIG. 2).

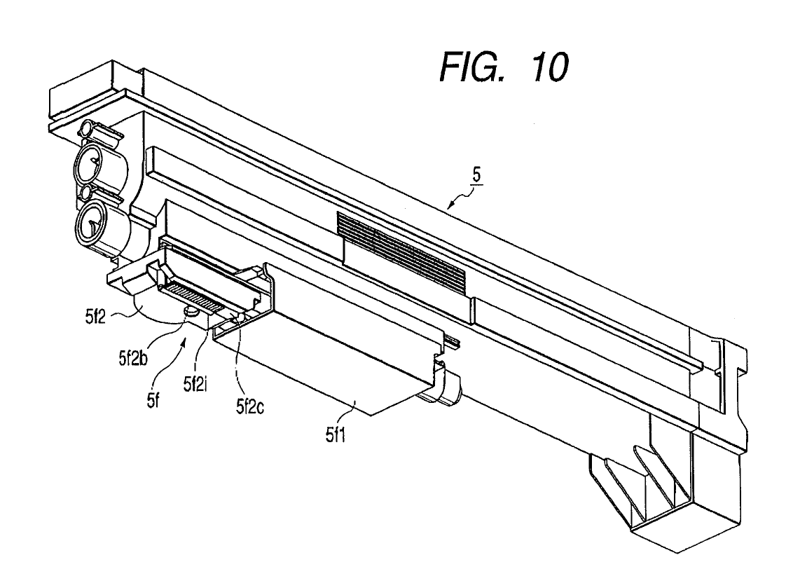

On the other hand, the discharge opening portion 5f for discharging toner to the process cartridge 1 is disposed in the bottom surface of the toner supplying container 5. As shown in the figure, when the toner supplying container 5 is outside the apparatus main body 100, the discharge opening portion 5f is covered by a discharge opening cover 5f1. The discharge opening cover 5f1 is movable along the rail portion 5h. When the toner supplying container 5 is inserted in the apparatus main body 100, the end surface in the inserting direction of the discharge opening cover 5f1 abuts a (not shown) convex portion provided in the apparatus main body 100, whereby the discharge opening cover 5f1 moves along the rail portion 5h and the discharge opening portion 5f is exposed (see FIG. 10).

In addition, the discharge opening cover 5f1 is energized in the direction of covering the discharge opening portion 5f by a (not shown) spring. When the toner supplying container 5 is pulled out of the apparatus main body 100, the discharge opening portion 5f is covered by the discharge opening cover 5f1 again.

Next, a toner leakage prevention structure of the toner supplying container 5 in accordance with the present invention will be described.

As shown in FIGS. 2 and 5, the discharge opening portion 5f for discharging toner into the process cartridge 1 is disposed in a part of the bottom surface of the toner supplying container 5 and a first opening portion 5f5 is formed in its central part. In addition, a first seal member 5f6 is disposed in the discharge opening portion 5f in the form of surrounding the circumference of the first opening 5f5. The first seal member 5f6 is adhered to the bottom surface part of the toner supplying container 5. Further, in this embodiment, the discharge opening portion 5f is disposed on a drive transmitting side of the screw 5a and the inner side in the inserting direction of the toner supplying container 5 (the right side in FIG. 5).

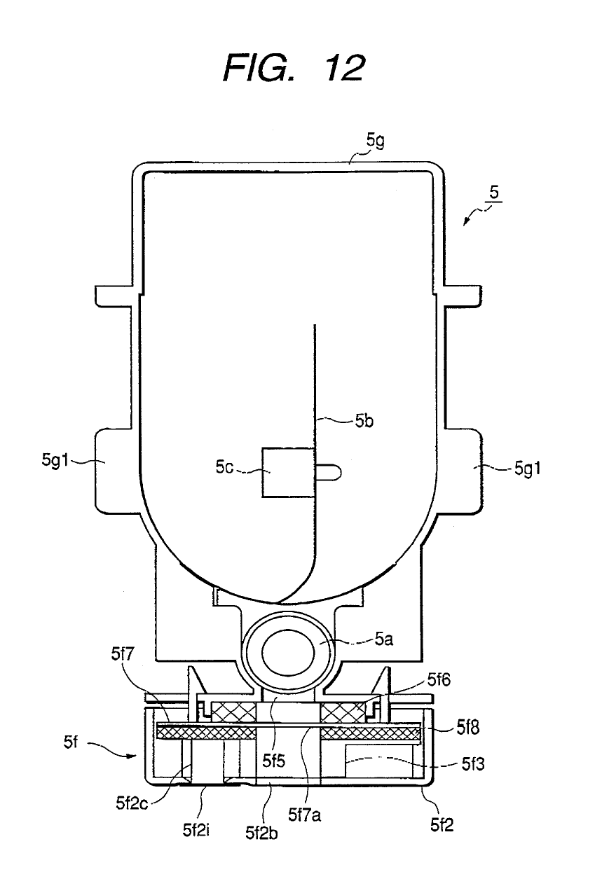

Here, a configuration in the vicinity of the first opening 5f5 will be described in detail with reference to FIG. 12. Note that, FIG. 12 is a longitudinal section of the discharge opening portion 5f of the toner supplying container 5 viewed from the inserting side of the toner supplying container 5.

As shown in FIG. 12, the first opening 5f5 that is a through-hole is formed below the screw 5a. The first seal member 5f6 is provided below the first opening 5f5. The first seal member 5f6 is provided for preventing toner from leaking from the circumference of the first opening 5f5. The first seal member 5f6 is made of an elastic member having a certain degree of thickness in which an opening of the same shape as the first opening 5f5 is formed. The first seal member 5f6 is supported with its upper surface attached to the bottom surface of the first opening 5f5. Further, although urethane foam is used as the first seal member 5f6 in this embodiment, the fist seal member 5f6 is not limited to urethane foam and any other member may be used as long as it has elasticity.

In addition, a seal plate 5f7 is provided below the first seal member 5f6 Since the seal plate 5f7 is supported by the first seal member 5f6 with its upper surface attached to the lower surface of the first seal member 5f6, the seal plate 5f7 can move vertical and diagonal directions following the elasticity of the first seal member 5f6. Further, in the seal plate 5f7, a third opening 5f7a that is a through-hole is formed in a position corresponding to the first opening 5f5 such that toner falls from the first opening 5f5 through the opening of the first seal member 5f6 and the third opening 5f7a of the seal plate 5f7.

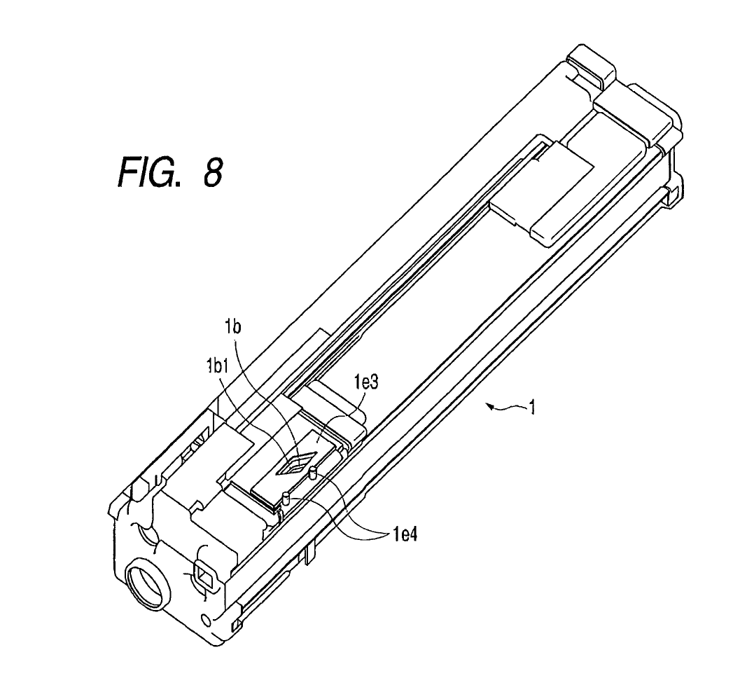

Moreover, a discharge opening shutter 5f3 and a pressing member 5f2 are disposed in the bottom surface part of the toner supplying container 5. The discharge opening shutter 5f3 opens and closes the first opening 5f5. The pressing member 5f2 is provided with both a function of holding the discharge opening shutter 5f3 to be open-closable to prevent it from falling and a function of coupling with a supply opening portion 1b (see FIG. 8) of the process cartridge 1.

The discharge opening shutter 5f3 is provided below the seal plate 5f7 and a second seal member 5f8 is sandwiched between the discharge opening shutter 5f3 and the seal plate 5f7. The second seal member 5f8 is for preventing toner from leaking from the circumference of a second opening 5f3b discussed below that is formed in the discharge opening shutter 5f3. The second seal member 5f8 is made of an elastic member with an opening provided in a position corresponding to the second opening 5f3b. Although the second seal member 5f8 is fixed with its lower surface attached to the discharge opening shutter 5f3, the upper surface of the second seal member 5f8 is not fixed to the lower surface of the seal plate 5f7 and is slidable. Further, as a material of the second seal member 5f8, one with elasticity and a low sliding resistance against the seal plate 5f7 is preferable, and urethane foam, urethane foam with a sliding sheet attached to its surface and the like can be used.

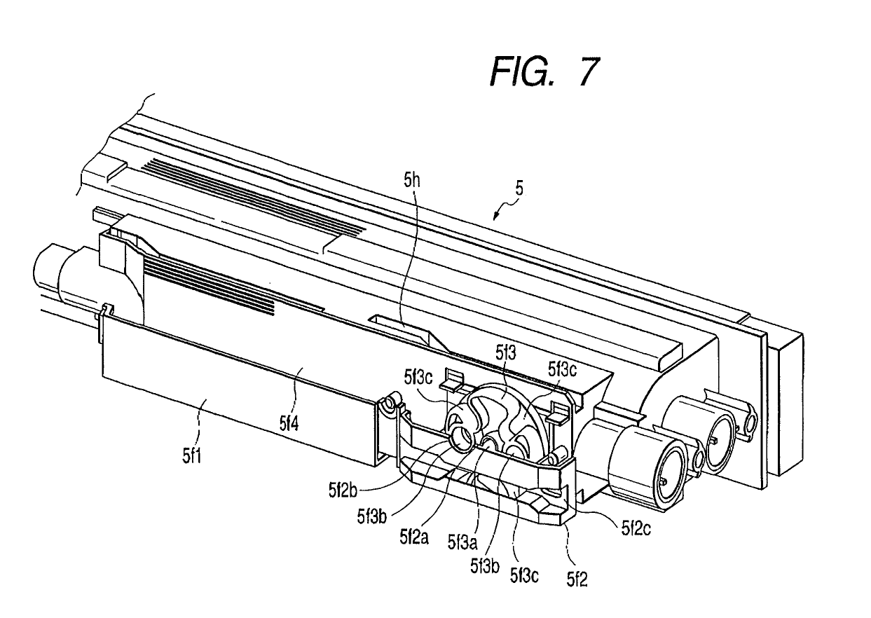

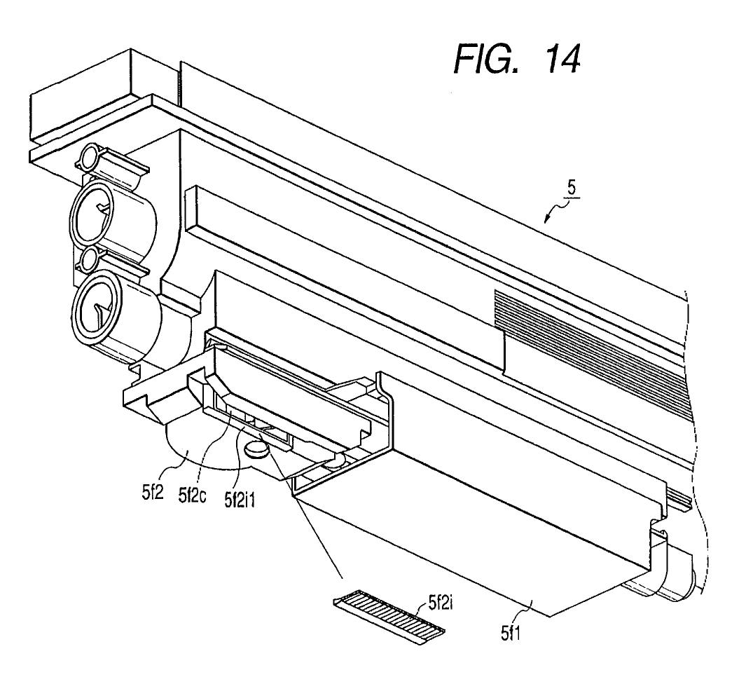

FIG. 7 is a perspective view of the toner supplying container 5 in a state in Which the discharge opening cover 5f1 and the discharge opening shutter 5f3 are opened viewed from the inner side of its bottom surface. For convenience, the figure shows a state in which a brush curtain 5f2i discussed below (see FIG. 14) is removed and the discharge opening cover 5f1 and the pressing member 5f2 are cut substantially in the middle in their longitudinal direction.

As shown in FIG. 7, the discharge opening shutter 5f3 has a rotational center 5f3a. Second openings 5f3b are disposed in two positions symmetrical with respect to the rotational center 5f3a. Slits 5f3c that are engaging portions for rotating the discharge opening shutter 5f3 are disposed in four positions 45° out-of-phase with respect to the second openings 5f3b. The discharge opening shutter 5f3 is held by the pressing member 5f2 that is a holding member of the discharge opening shutter 5f3 and, at the same time, is provided with a function of coupling with the supply opening portion 1b of the process cartridge 1.

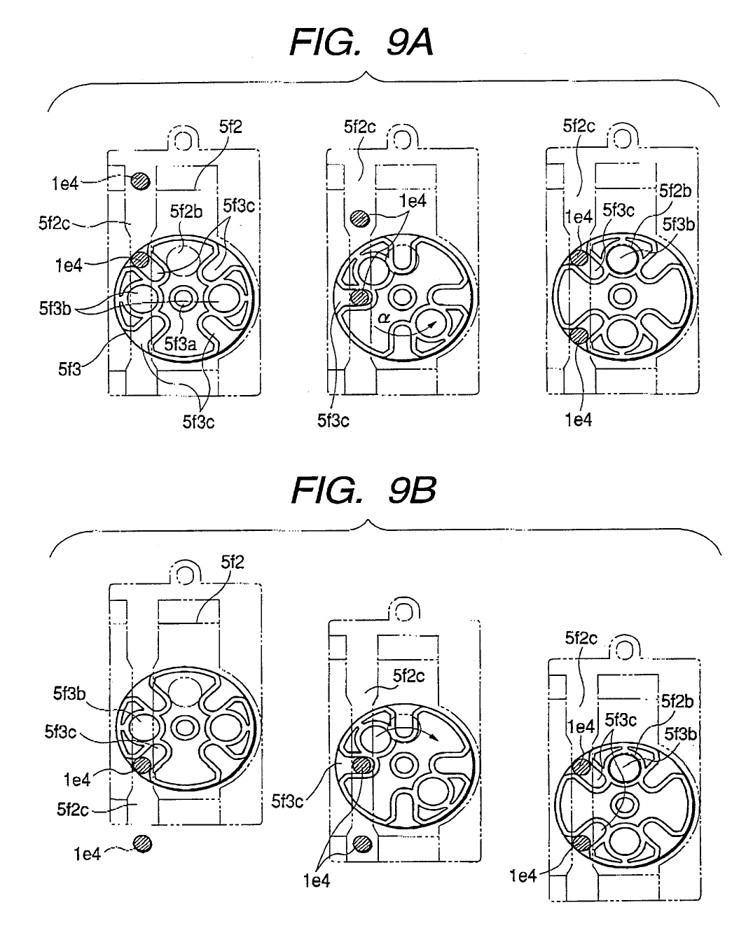

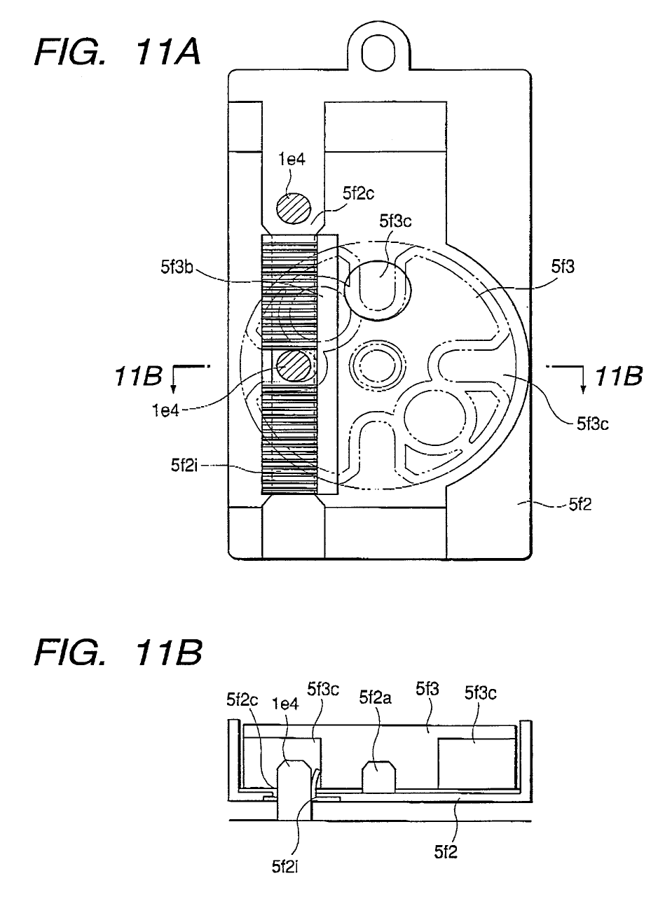

In the pressing member 5f2, a pin 5f2a for rotatably supporting the discharge opening shutter 5f3 is provided substantially vertically as shown in FIGS. 11A and 11B and a fourth opening 5f2b that is a through opening for supplying toner is opened as shown in FIGS. 9A and 9B. In addition, the pressing member 5f2 is provided with a slit 5f2c forming a substantially straight shape in its longitudinal direction. FIG. 8 is a perspective view of the upper surface part of the process cartridge 1 in accordance with this embodiment. As shown in the figure, a supply opening 1b1 is formed in the supply opening portion 1b that is a supply portion of toner supplied from the toner supplying container 5. The supply opening 1b1 is a through-hole forming a passage through which toner supplied from the toner supplying container 5 falls. A seal member 1e3 made of an elastic body having an opening of the same shape as the supply opening 1b1 is provided in the supply opening 1b1. The seal member 1e3 prevents toner from leaking from the circumference of the supply opening 1b1.

In addition, two guide pins (moving bodies) 1e4 for rotating the discharge opening shutter 5f3 provided in the toner supplying container 5 are disposed beside the seal member 1e3. The supply opening 1b1 is a through-hole of a substantially parallelepiped shape. A pair of opposing sides of the through-hole are arranged in parallel with each other in its longitudinal direction and the seal member 1e3 is provided to cover its circumference. The seal member 1e3 is for keeping a sealing property when the supply opening 1b1 contacts the pressing member 5f2 of the toner supplying container 5. The seal member 1e3 desirably not only has elasticity but also has high toner removing performance and a low sliding resistance. Further, as the seal member 1e3, for example, Teflon felt, Teflon pile, urethane foam or electrostatic flocking can be used.

FIGS. 9A and 9B illustrate operation states of the discharge opening shutter 5f3. FIG. 9A illustrates a state transition of operations of the discharge opening shutter 5f3 of the toner supplying container 5 at the time when the process cartridge 1 is being inserted. That is, FIG. 9A illustrates a state transition from the left to the right in the figure at the time when the process cartridge 1 is being inserted in the apparatus main body 100 in which the toner supplying container 5 has been mounted in advance. In addition, FIG. 9B illustrates a state transition of operations of the discharge opening shutter 5f3 of the toner supplying container at the time when the toner supplying container 5 is being inserted. That is, FIG. 9B illustrates a state transition from the left to the right in the figure at the time when the toner supplying container 5 is being inserted in the apparatus main body 100 in which the process cartridge 1 has been mounted in advance.

As shown in FIG. 9B, if the process cartridge 1 has been mounted in the apparatus main body 100 already, the guide pins 1e4 are made immobile (there is no change in their positions). When the toner supplying container 5 is inserted, the guide pin 1e4 on the front side formed in the process cartridge 1 is guided by the slit 5f2c opened in the pressing member 5f2 to engage the slit 5f3c provided in the discharge opening shutter 5f3 (the left in FIG. 9B). Since the second opening 5f3b generates a 90° phase with respect to the first opening 5f5 in this state, the first opening 5f5 maintains a state in which it is closed by the discharge opening shutter 5f3.

Moreover, when the toner supplying container 5 is inserted, the discharge opening shutter 5f3 starts rotation in a á direction around the rotational center 5f3a (the center in FIG. 9B). When the toner supplying container 5 is completely inserted to the mounted position, the discharge opening shutter 5f3 rotates to a position shown in the right in FIG. 9B. Then, the first opening 5f5 formed in the toner supplying container 5 and the second opening 5f3b formed in the discharge opening shutter 5f3 coincide with each other to allow discharge of the toner.

Similarly, as shown i n FIG. 9A, if the toner supplying container 5 has already been mounted in the apparatus main body 100 already, the discharge opening shutter 5f3 is made rotatable in an immobile position. Then, when the process cartridge 1 is inserted, the guide pin 1e4 on the inner side formed in the process cartridge 1 is guided by the slit 5f2c opened in the pressing member 5f2 to engage the slit 5f3c provided in the discharge opening shutter 5f3 (the left in FIG. 9A). Since the second opening 5f3b generates a 90° phase with respect to the first opening 5f5 in this state, the first opening 5f5 turns into a state in which it is closed by the discharge opening shutter 5f3.

Moreover, when the process cartridge 1 is inserted, the discharge opening shutter 5f3 starts rotation in a á direction around the rotational center 5f3a (the center in FIG. 9A). When the process cartridge 1 is completely inserted to the mounted position, the discharge opening shutter 5f3 rotates to a position shown in the right in FIG. 9A. Then, the first opening 5f5 formed in the toner supplying container 5 and the second opening 5f3b formed in the discharge opening shutter 5f3 coincide with each other to allow discharge of the toner.

Further, it is needless to mention that the position of the first opening 5f5 formed in the toner supplying container 5 and the position of the supply opening 1b1 formed in the process cartridge 1 coincide with each other in the states shown in the right in FIGS. 9A and the right in FIG. 9B.

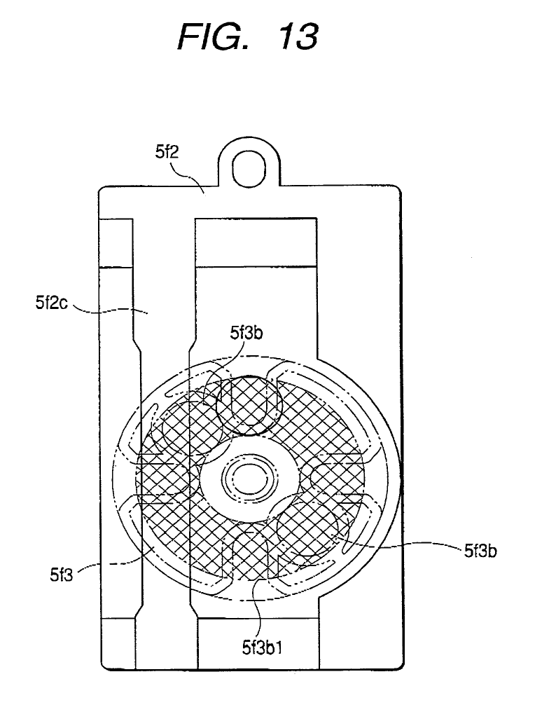

However, since the discharge opening shutter 5f3 is associated with insertion and pulling out of both of the process cartridge 1 and the toner supplying container 5, the second opening 5f3b draws a moving locus 5f3b1 (area shown by grids) as shown in FIG. 13. Thus, the second opening 5f3b opposes the slit 5f2c in a certain area of the moving locus 5f3b1. In particular, when the discharge opening shutter 5f3 is in a closed state, the second opening 5f3b surely opposes the slit 5f2c. The second opening 5f3b is a hole through which toner passes and it is highly likely that toner is adhered to its wall surface. Therefore, it is possible that the toner adhered to the wall surface scatters to the outside from the slit 5f2c by vibration or the like in the inserting and pulling out operations of the process cartridge 1 and the toner supplying container 5.

In a state in which the toner supplying container 5 is removed from the apparatus main body 100, since the slit 5f2c is covered by the discharge opening cover 5f1, toner does not make, for example, a user's hand or cloths dirty. However, the toner may make the circumference of the guide pins 1e4 of the process cartridge 1 dirty in the apparatus main body 100.

FIG. 10 is a perspective view of the toner supplying container 5 in accordance with the present invention viewed diagonally from the bottom surface side on its inner side. The figure shows a state in which the discharge opening cover 5f1 retracts in a position for exposing the discharge opening portion 5f.

As shown in the figure, the slit 5f2c opened in the pressing member 5f2 is covered by the brush curtain 5f2i.

FIG. 11A and 11B schematically show a function of the brush curtain 5f2i. FIG. 11A shows the toner supplying container 5 viewed from its bottom surface direction and also show the pressing member 5f2, the discharge opening shutter 5f3, the guide pin 1e4 and the brush curtain 5f1. FIG. 11B is a longitudinal section in an illustrated position of FIG. 11A.

A tip of a brush of the brush curtain 5f2i points to a direction crossing the longitudinal direction of the slit 5f2c. As shown in FIGS. 11A and 11B, when the guide pin 1e4 passes through the slit 5f2c, the brush curtain 5f2i retracts only at the part of the guide pin 1e4 to allow the slit 5f3c of the discharge opening shutter 5f3 and the guide pin 1e4 to engage with each other. The guide pin 1e4 and the slit 5f3c engage with each other as described above and the discharge opening shutter 5f3 performs opening and closing operations following the movement of the guide pin 1e4. At this point, although the brush at the part of the guide pin 1e4 retracts from the guide pin 1e4 because the brush of the brush curtain 5f2i is flexible, the part of the slit 5f2c where the guide pin 1e4 does not exist is covered by the brush curtain 5f2i. This retracting part moves following the movement of the guide pin 1e4 and the brush curtain 5f2i covers the slit 5f2c in the other parts. Even if the second opening 5f3b moves to an area opposing the slit 5f2c, since the slit 5f2c is covered by the brush curtain 5f2i as described above, toner does not scatter to the outside.

Next, an attaching position of the brush curtain 5f2i will be described In this embodiment, the brush curtain 5f2i is disposed on an external wall surface of the pressing member 5f2 as shown in the sectional view FIG. 11B of FIG. 11A. This is for preventing peeling of the brush by the guide pin 1e4. That is, as shown in the figure, the brush bends upward by the guide pin 1e4 and, if the brush curtain 5f2i is disposed on an internal wall part, a load acts in the direction in which the brush peels. Thus, an attaching strength of the brush curtain 5f2i must be increased by an amount equivalent to the load.

Further, although the brush curtain 5f2i is adhered to a predetermined position 5f2i1 of the pressing member 5f2 by a double-faced adhesive tape (see FIG. 14) in this embodiment, as a fixing method of the brush curtain 5f2i, an adhesive, a heat seal and the like can be appropriately selected.

In addition, as a material of the brush, any material may be appropriately selected as long as it is flexible. For example, chemical fiber such as nylon and polypropylene, animal fiber such as horse hair and pig hair, and plant fiber such as hemp and palms can be used.

Moreover, as a form of fiber forming the brush, a curly hair type can be selected other than a usual straight hair type. If a space in the height direction of the attaching part of the brush curtain 5f2i cannot be secured sufficiently, a density of the brush falls and, as a result, it is possible that toner scatters from gaps in the fiber of the brush. However, if the curly hair type brush fiber is used as the brush, there is an advantage in that toner can be prevented from scattering to the outside because the volume of the brush increases by the curling of the fiber.

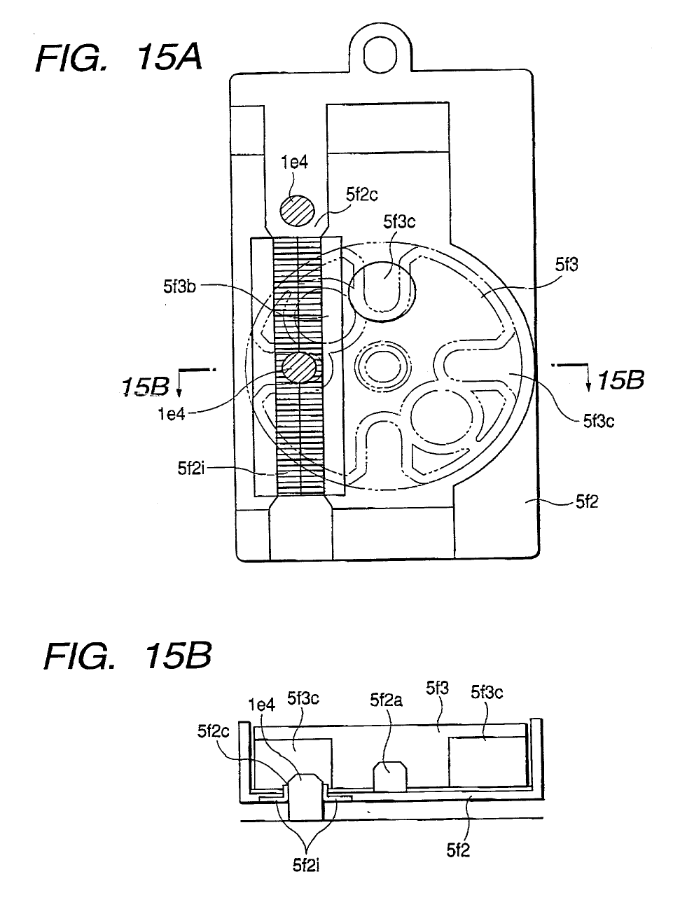

The above descriptions are concerning the form in which bristles extend from one side of the slit. However, as shown in FIGS. 15A and 15B, the brush curtain 5f2i is constituted of two brushes whose tips of bristles points to the center of the slit 5f2c from both the sides of the slit 5f2c. whereby toner can be prevented from scattering.

Further, in the above description, the configuration in which the brush curtain covers the slit, through which the convex part for opening and closing the discharge opening shutter provided in a holding member for holding the discharge opening shutter open-closable passes, is described. However, in a configuration in which it is possible that toner scatters from an opening through which the convex part for moving a certain member passes, if this opening is covered by a brush member whose tips of bristles point to the direction crossing with respect to the moving direction of the convex part, scattering of the toner can be prevented easily.

While the described embodiment represents the preferred form the present invention. It is to be understood that modifications will occur to those skilled in that art without departing from the spirit of the invention. The scope of the invention is therefore to be determined solely by the appended claims.

What is claimed is:

1. An image forming apparatus comprising:
a unit detachably attachable to a main assembly of the image forming apparatus, said unit having a discharge opening for discharging a developer and a shutter for opening and closing said discharge opening; and
developing means for developing a latent image formed on an image bearing member by the developer, said developing means having a supply opening connected to said discharge opening,
wherein said unit has a groove through which a moving body for moving said shutter passes and wherein a brush member is attached to said groove.

2. An image forming apparatus according to claim 1,
wherein said brush member has tips of bristles pointing to a direction crossing a moving direction of the moving body.

3. An image forming apparatus according to claim 1,
wherein said developing means is detachably attachable to the main assembly of the image forming apparatus and said moving body is attached to said developing means.

4. An image forming apparatus according to claim 3,
wherein said shutter opens and closes said discharge opening by relative movements of said unit and said developing means.

5. An image forming apparatus according to claim 1,
wherein said shutter has a hole through which the developer passes and the hole is movable to a position where the hole overlaps said groove.

6. An image forming apparatus comprising:
developing means for developing a latent image formed on an image bearing member by a developer, said developing means being detachably attachable to a main assembly of the image forming apparatus; and
a supplying container for containing the developer to be supplied to said developing means, said supplying container having a discharge opening for discharging the developer and a shutter for opening and closing said discharge opening,
wherein said supplying container has a groove through which a moving body for moving said shutter passes and wherein a brush member is attached to said groove.

7. An image forming apparatus according to claim 6,
wherein said brush member has tips of bristles pointing to a direction crossing a moving direction of the moving body.

8. An image forming apparatus according to claim 6,
wherein said moving body is attached to said developing means.

9. An image forming apparatus according to claim 6,
wherein said shutter has a hole through which the developer passes, the hole being movable to a position where the hole overlaps said groove.

10. A unit detachably attachable to an image forming apparatus, comprising:
a groove through which a part of a moving body that is movable relative to said unit passes; and
a brush member attached to said groove,
wherein, when the moving body passes through said groove, the moving body contacts said brush member.

11. A unit detachably attachable to an image forming apparatus according to claim 10,
wherein said brush member has tips of bristles pointing to a direction crossing a relative moving direction of the moving body.

12. A unit detachably attachable to an image forming apparatus according to claim 10,
wherein said unit has a containing portion for containing a developer.

13. A unit detachably attachable to an image forming apparatus according to claim 12,
said unit has a discharge opening for discharging a developer and a shutter for opening and closing said discharge opening and said shutter moves by relative movement with said moving body.

14. A unit detachably attachable to an image forming apparatus according to claim 13,
wherein said shutter has a hole through which the developer passes, the hole being movable to a position where the hole overlaps said groove.
